(19) United States
(12) Patent Application Publication
(10) Pub. No.: US 2022/0192306 A1
(43) Pub. Date: Jun. 23, 2022

(54) MASK COMBINED MUFFLER AND INTEGRAL DETACHABLE TRIPLE HAT HAVING THE SAME

(71) Applicant: Sang Balk AN, Seoul (KR)

(72) Inventor: Sang Balk AN, Seoul (KR)

(21) Appl. No.: 17/554,287

(22) Filed: Dec. 17, 2021

(30) Foreign Application Priority Data
Dec. 18, 2020 (KR) 20-2020-0004679

(51) Int. Cl. A42B 1/24; A41D 13/11; A42B 7/00; A62B 23/02

(52) U.S. Cl. CPC A42B 1/24; A62B 23/025; A42B 7/00; A41D 13/1161

(57) ABSTRACT

An integral detachable triple hat according to an embodiment of the present disclosure includes a hat part, a muffler part detachably coupled to the hat part and covering a portion of a face of a wearer, and a mask part detachably coupled to the muffler part and filtering fine dust or viruses by covering a mouth and nose of the wearer, a mask filter for filtering is provided in the mask part, and the mask filter is replaceable.

### CROSS-REFERENCE TO RELATED APPLICATION(S)

This application claims the benefit under 35 USC § 119(a) of Korean Utility Model Application No. 20-2020-0004679, filed on Dec. 18, 2020, in the Korean Intellectual Property Office, the entire disclosure of which is incorporated herein by reference for all purposes.

### BACKGROUND

### 1. Field

The following description relates to a mask combined muffler and an integral detachable triple hat having the same, and more particularly, to a mask combined muffler and an integral detachable triple hat having the same, capable of selectively coupling a muffler part and a mask part to a hat part, or the mask part to the muffler to allow a wearer to keep warm and to block fine dust or viruses through the mask part, thereby helping the wearer keep healthy.

### 2. Description of Related Art

In general, hats are worn on the head to protect the head from sunlight, rain, or snow, are classified into various types according to the purpose or usage, and are used as a means to create a stylish look according to the taste or personality of a user.

Hats can be made in various ways depending on the purpose of use, and there is also a hat with a muffler. This type of hat has an advantage of keeping the entire face warm in the cold winter as it can cover the ears, the back of the head, and the chin with a muffler part.

Meanwhile, in recent years, it has become common to wear a mask due to fine dust including ultrafine dust and viruses such as corona virus. However, for example, when a mask is worn while a muffler combined hat is being worn, there is a complexity in the process of putting on and taking off the mask since the ears are covered.

Therefore, a hat with a mask and muffler function has been invented and used, but in this case, the mask is only for covering the mouth or nose, and as a consequence, there is a limit to filtering fine dust or removing viruses such as corona virus, and there is a risk that health problems may occur, accordingly.

Therefore, there is a need to develop a multi-functional hat of a new structure, capable of, while having the function of a hat itself, selectively providing the effect of keeping warm to a wearer in cold winter, and including a mask having a reliable filtering function.

Examples of the related art include Korea Utility Model Publication No. 20-2020-0002492 (Title: a mask combined hat) and the like.

### SUMMARY

The disclosed embodiments are intended to provide an integral detachable triple hat capable of selectively coupling a muffler part and a mask part to a hat part to allow a wearer to keep warm and to block fine dust or viruses through the mask part, thereby helping the wearer keep healthy.

In addition, the disclosed embodiments are intended to provide a mask combined muffler capable of selectively coupling a mask part to a muffler part to allow a wearer to keep warm and to block fine dust or viruses through the mask part, thereby helping the wearer keep healthy.

The problem(s) to be solved by the present disclosure is (are) not limited to that (those) mentioned above, and another problem(s) not mentioned will be clearly understood by those skilled in the art from the following description.

In one general aspect, there is provided an integral detachable triple hat including a hat part, a muffler part detachably combined to the hat part and covering a portion of a face of a wearer, and a mask part detachably combined to the muffler part and filtering fine dust or viruses by covering a mouth and nose of the wearer, in which a mask filter for filtering is provided in the mask part and the mask filter is replaceable.

According to an embodiment of the present disclosure, the mask part may be provided by coupling an inner shell to an outer shell to form an open portion with an open top so that the mask filter is inserted into the open portion and positioned between the inner shell and the outer shell.

According to an embodiment of the present disclosure, a zipper may be provided at the ends of the inner shell and the outer shell forming the open portion of the mask part to close the open portion after the mask filter is inserted into the mask part.

According to an embodiment of the present disclosure, the upper end of the mask part may be provided with a nose support for bringing the mask part to sit closer to the nose of the wearer.

According to an embodiment of the present disclosure, elastic lines for pulling the mask part to both sides and stoppers for fixing the elastic lines may be provided at both sides of the mask part to adjust a degree of wearing of the mask part with respect to the face of the wearer.

According to an embodiment of the present disclosure, the mask filter may be any one of a filter for health, a filter for quarantine, or a filter for yellow dust blocking.

According to an embodiment of the present disclosure, a button fastening member may be provided along inner or outer edge of a lower end of the hat part, and a button member fastened to the button fastening member may be provided at the muffler part.

According to an embodiment of the present disclosure, the muffler part may include a first protection member covering ears and a chin of the wearer and a second protection member integrally connected to the first protection member and covering a portion of side and back hair of the wearer, and the second protection member may be divided into two portions such that one portion is combined to the other portion to adjust a degree of closeness of the muffler part to a body part of the wearer.

According to an embodiment of the present disclosure, the second protective member may be provided with a Velcro for selectively coupling the other portion to the one portion of the second protection member.

According to an embodiment of the present disclosure, the muffler part and the mask part may be detachably coupled to each other by a zipper.

According to an embodiment of the present disclosure, the muffler part may be provided with a mask coupling member to temporarily store the mask part separated from the muffler part, and a button coupling member that is button combined with the mask coupling member may be provided at one side of the mask part.

According to an embodiment of the present disclosure, the muffler part may be a protector that covers ears, a face side, and a chin in the face of the wearer.

In another general aspect, there is provided a mask combined muffler including a muffler part covering a portion of a face of a wearer, and a mask part detachably coupled to the muffler part and filtering fine dust or viruses by covering a mouse and nose of the wearer, in which a mask filter for filtering is provided in the mask part and the mask filter is replaceable.

### BRIEF DESCRIPTION OF THE DRAWINGS

FIG. 1 is a schematic perspective view of an integrated detachable multi-functional hat according to an embodiment of the present disclosure.

FIG. 2 is a view from the back of the multi-functional hat shown in FIG. 1.

FIG. 3 is an exploded perspective view of a muffler part and a mask part of the multi-functional hat shown in FIG. 2.

FIG. 4 is a view showing a state in which the mask filter is fastened to the mask part of the multi-functional hat shown in FIG. 1.

FIG. 5 is a schematic perspective view of a multi-functional hat according to another embodiment of the present disclosure.

### DETAILED DESCRIPTION

Advantages and/or features of the inventive concept, and methods for achieving the advantages and features will be clarified with reference to embodiments described below in detail together with the accompanying drawings. However, the present disclosure is not limited to the embodiments disclosed below, but will be implemented in a variety of different forms. The present embodiments are only provided to allow the present disclosure to be complete, and to completely inform those skilled in the art of the scope of the disclosure, and the present disclosure is merely defined by scope of the claims. Like reference numerals refer to like elements throughout the specification.

Hereinafter, embodiments of the present disclosure will be described in detail with reference to the accompanying drawings.

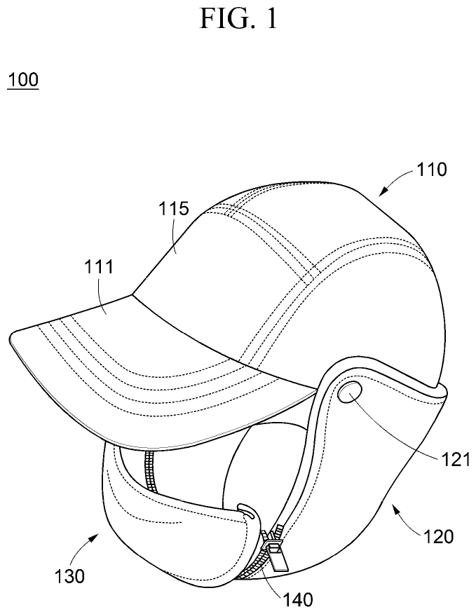

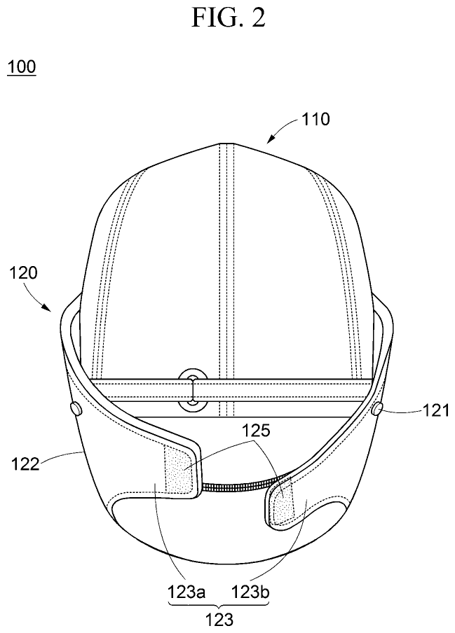

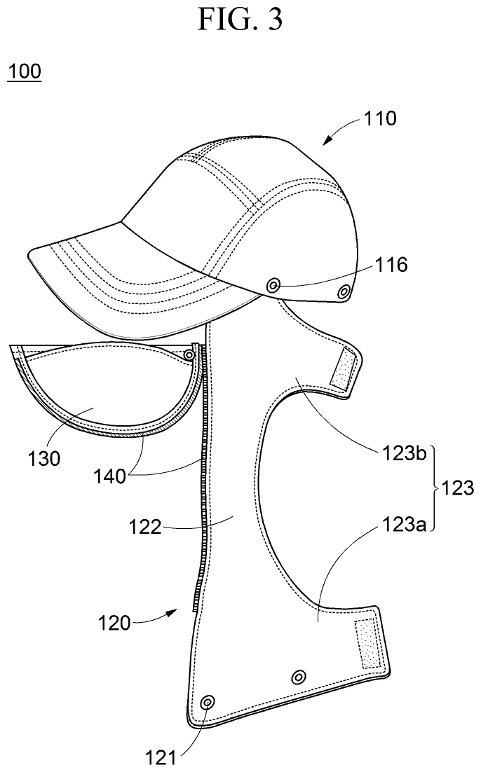

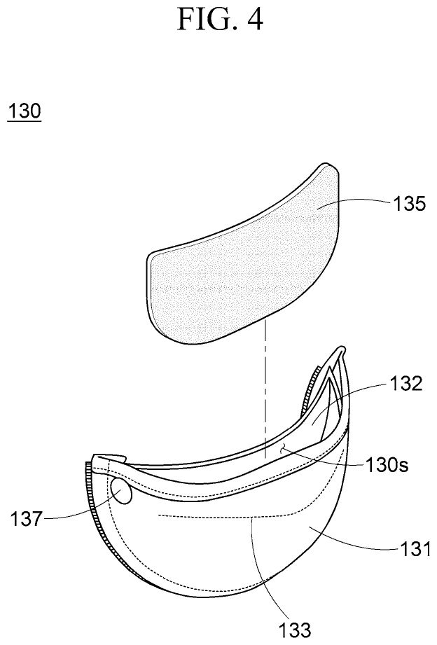

FIG. 1 is a schematic perspective view of an integrated detachable multi-functional hat according to an embodiment of the present disclosure, FIG. 2 is a view from the back of the multi-functional hat shown in FIG. 1, FIG. 3 is an exploded perspective view of a muffler part and a mask part of the multi-functional hat shown in FIG. 2, and FIG. 4 is a view showing a state in which the mask filter is fastened to the mask part of the multi-functional hat shown in FIG. 1.

As shown in the drawings above, an integrated detachable multi-functional hat 100 according to an embodiment of the present disclosure is a hat capable of implementing all a hat function, a muffler function, and a mask function, and may include a hat part 110, a muffler part 120 detachably coupled to the hat part 110, and a mask part 130 detachably coupled to the muffler part 120.

With the above configuration, the multi-functional hat 100 of the present embodiment may be used only as a hat by separating the muffler part 120 and the mask part 130 from the hat part 110, may be used as a muffler combined hat by coupling the muffler part 120 to the hat part 110, and may be used as a mask and muffler combined hat by coupling the mask part 130 to the muffler part 120.

In addition, a mask filter 135 is provided in the mask part 130 of the present embodiment, and the mask filter 135 is replaceable, and thus it is possible to provide a mask having an excellent filtering function, not just a simple mask shape.

Describing each component, first, the hat part 110 of the present embodiment is a cap-shaped hat as shown in FIG. 1, and may include a body part 115 covering the head and a brim part 111 shielding the face of a person against sunlight or the like. The inner side of the body part 115 may be provided with a fleece to increase the effect of keeping warm.

Meanwhile, as shown in FIGS. 1 to 3, the muffler part 120 functions as a protector detachably coupled to the hat part 110 to cover the ears and face side, chin, and side and back hair of the wearers, and the wearer of the muffler part 120 may keep warm with the muffler part 120 without a separate muffler when it is cold like winter.

The inner side of the muffler part 120 may be provided with a fleece, thereby increasing the effect of keeping warm. However, the muffler part 120 is not limited to the above.

As described above, the muffler part 120 may be selectively coupled to the hat part 110. For this purpose, as shown in FIG. 3, along an edge of the lower end of the body part 115 of the hat part 110, a button fastening member 116 for button fastening may be provided. In addition, a button member 121 may be provided in the muffler part 120 so that the button member 121 of the muffler part 120 may be fastened to the button fastening member 116 of the hat part 110.

However, the fastening method is not limited thereto, and for example, a zipper (not shown) for zipper-coupling may be provided at corresponding positions of the hat part 110 and the muffler part 120, or a Velcro may be provided at corresponding positions of the hat part 110 and the muffler part 120 so that they may be Velcro-coupled.

As shown in FIGS. 1 to 3, the muffler part 120 of the present embodiment may include a first protection member 122 that covers the ears and chin of the wearer, and a second protection member 123 that is integrally connected with the first protection member 122 and covers a portion of the side head and back head of the wearer.

Referring to FIGS. 2 and 3, the second protection member 123 has a configuration in which it is divided into two portions such that one portion 123a is coupled to the other portion 123b, through which the degree of closeness of the muffler part 120 to the body part of the wearer may be adjusted.

For this purpose, a Velcro 125 may be provided on the outer side of the one portion 123a of the second protection member 123 and the inner side of the other portion 123b, through which a selective coupling of the other portion 123b to the one portion 123a of the second protection member 123 is possible, and thus the muffler part 120 may be adjusted to fit the shape of the face of the wearer.

In addition, by the optional Velcro coupling of the second protection member 123, the wearing degree of the mask part 130 to be described later may also be adjusted. For example, when the second protection member 123 is pulled and fastened, the mask part 130 is also pulled to both sides, so that the mask part 130 may sit closer to the mouth of the wearer, and conversely, when the second protection member 123 is loosely fastened, the mask part 130 is also loosened, thereby loosening the degree of closeness of the mask part 130 to the mouth of the wearer.

As described above, in the present embodiment, the coupling of the muffler part 120 to the hat part 110 may be made to be detachable, and the degree of closeness of the muffler part 120 may be adjusted according to the needs of the wearer.

Meanwhile, as shown in FIGS. 1 to 3, the mask part 130 of the present embodiment is detachably coupled to the muffler part 120 to cover the mouth and nose of the wearer, making it possible to filter fine dust or viruses.

As shown in FIGS. 1 and 3, the mask part 130 may be selectively coupled to the muffler part 120 by a zipper coupling method. That is, by coupling the mask part 130 to one side of the muffler part 120 and lifting a zipper 140, the mask part 130 may be coupled to the muffler part 120.

As shown in FIG. 4, the mask part 130 of the present embodiment has a double layered structure with the top being open and the other part being closed, thereby providing a mask of a pocket type with an open top as a whole. That is, the mask part 130 may include an outer shell 131 facing outward and an inner shell 132 facing the mouth and nose of the wearer, and by inserting the mask filter 135 through the open portion 130s between the outer shell 131 and the inner shell 132, foreign substances such as fine dust or viruses from the outside may be filtered.

The mask filter 135 of the present embodiment may be any one of a mask filter for health, a mask filter for quarantine, or a mask filter for yellow dust blocking, and the wearer may replace the mask filter 135 as needed. The mask filter 135 may be provided with an adhesive sticker (not shown) having an adhesive force, and thus, the mask filter 135 may be positioned in the mask part 130, and then firmly secured by the adhesive force of the adhesive sticker.

In addition, although not shown, a zipper is provided on the open portion 130s of the mask part 130, and thus, by inserting the mask filter 135 into the mask part 130 and then closing the open portion 130s, contamination of the mask filter 135 by external contact may be prevented, and the position of the mask filter 135 may be stably maintained.

Further, as shown in FIG. 4, the upper end of the mask part 130 may be provided with a nose support 133 for bringing the mask part 130 to sit closer to the nose of the wearer. The nose support 133 may be provided in the form of a thin and long metal bar, and the nose support 133 may be brought to sit closer to fit shape of the nose of the wearer, which makes it possible to prevent fine dust, viruses, or the like, from entering between the mask part 130 and the nose of the wearer, and to prevent fogging of the glasses due to snoring or breathing for glasses wearers.

In addition, although not shown, elastic lines for pulling the mask part 130 to both sides and stoppers for fixing the elastic lines are provided on both sides of the mask part 130 to adjust the degree of wearing of the mask part with respect to the face of the wearer, making it possible for the mask part 130 to be securely worn.

Meanwhile, when the mask part 130 is separated from the muffler part 120, there is a risk of losing the mask part 130 when the mask part 130 is separately stored. Accordingly, in the present embodiment, in order to temporarily store the mask part 130 separated from the muffler part 120, a mask coupling member (not shown) for coupling the mask part 130 may be provided in the muffler part 120, and a button coupling member 137 that is button coupled to the mask coupling member may be provided on one side of the mask part 130.

As described above, according to the present embodiment, it is possible to selectively couple the muffler part 120 and the mask part 130 to the hat part 110, and accordingly, it is possible to allow the wearer to keep warm and to block fine dust or viruses through the mask part 130, thereby helping the wearer keep healthy.

In addition, according to the present embodiment, due to the detachable function of the mask part 130 and the muffler part 120, it is possible to use each of the hat part 110 and the muffler part 120 individually, and accordingly, it is possible to expect the effect of improving practicality from the user's point of view.

Meanwhile, hereinafter, the description of the multi-functional hat 100 according to another embodiment of the present disclosure will be given, but the description of the parts corresponding to the components of the hat of the above-described embodiment will not be repeated.

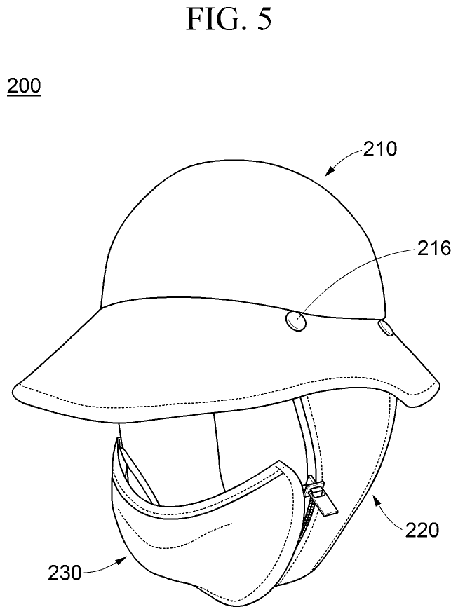

FIG. 5 is a schematic perspective view of the multi-functional hat 100 according to another embodiment of the present disclosure.

As shown in FIG. 5, the integrated detachable multi-functional hat 200 of the present embodiment may include a hat part 210 in the form of a bungee hat, a muffler part 220 coupled thereto, and a mask part 230 coupled to the muffler part 220.

In the present embodiment, as in the above-described embodiment, a mask filter in the mask part 230 may be replaced as needed.

In the above-described embodiment, it has been described that the button fastening member 116 is provided in the hat part 110 (see FIG. 3) and the button member 121 fastened to the button fastening member 116 is provided in the muffler part 120; in contrast, in the present embodiment, the button member 216 is provided on the hat part 210, and a button fastening member (not shown) is provided on the muffler part 220 such that the coupling between the two can be made.

Although it has been described in detail in the above-described embodiments that the muffler part and the mask part are selectively coupled to the hat part, it is possible to provide only a muffler to which the mask part is fastened without the hat part.

Although the case in which the cap hat or the bungee hat is applied as the type of the hat has been described above in the above-described embodiments, the present disclosure is not limited thereto, and it is obvious that the muffler part may be coupled to another type of hat part, such as a fedora hat. That is, the aforementioned hat part may be compatible with various types of hats, such as a cap hat, a bungee hat, or a fedora hat.

According to embodiments of the present disclosure, it is possible to selectively couple the muffler part and the mask part to the hat part, and accordingly, it is possible to allow the wearer to keep warm and to block fine dust or viruses through the mask part, thereby helping the wearer keep healthy.

In addition, according to the embodiments of the present disclosure, due to the detachable function of the mask part and the muffler part, it is possible to use each of the hat part and the muffler part individually, and accordingly, it is possible to expect the effect of improving practicality from the user's point of view.

Although specific embodiments according to the present disclosure have been described so far, various modifications can be made without departing from the scope of the present disclosure. Therefore, the scope of the present disclosure should not be limited to the described embodiments, but should be defined not only by the claims set forth below but also by equivalents of the claims.

As mentioned above, although the present disclosure has been described with reference to limited embodiments and drawings, the present disclosure is not limited to the above-described embodiments, and various modifications and changes could be made from the descriptions by those of ordinary skill in the art to which the present disclosure pertains. Accordingly, the spirit of the present disclosure should be understood only by the claims set forth below, and all equivalents or equivalent modifications thereof will fall within the scope of the spirit of the present disclosure.

What is claimed is:

1. An integral detachable triple hat comprising:
a hat part;
a muffler part detachably coupled to the hat part and covering a portion of a face of a wearer;
a mask part detachably coupled to the muffler part and filtering fine dust or viruses by covering a mouth and nose of the wearer, the mask part having an inner shell and an outer shell, the mask part comprising:
a mask filter provided in the mask part, the mask filter being replaceable, wherein the mask part is provided by coupling the inner shell and the outer shell to each other to form an open portion with an open top so that the mask filter is inserted into the open portion and positioned between the inner shell and the outer shell;
a zipper provided at the ends of the inner shell and the outer shell forming the open portion of the mask part to close the open portion after the mask filter is inserted into the mask part;
a nose support at the upper end of the mask part for bringing the mask part to sit closer to the nose of the wearer; and
elastic lines for pulling the mask part and stoppers for fixing the elastic lines at both sides of the mask part to adjust a degree of wearing of the mask part with respect to the face of the wearer;
a mask coupling member provided the muffler part to temporarily store the mask part separated from the muffler part; and
a button coupling member provided at one side of the mask part to be coupled to the mask coupling member.

2. The integral detachable triple hat of claim 1, wherein the mask filter is selected from the group consisting of a filter for health, a filter for quarantine, a filter for yellow dust blocking, and a combination thereof.

3. The integral detachable triple hat of claim 1, further comprising:
a button fastening member provided along an inner or outer edge of a lower end of the hat part; and
a button member provided at the muffler part and fastened to the button fastening member.

4. The integral detachable triple hat of claim 3, wherein the muffler part comprises:
a first protection member covering ears and a chin of the wearer; and
a second protection member integrally connected to the first protection member and covering a portion of side and back hair of the wearer, wherein the second protection member is divided into two portions such that one portion is coupled to the other portion to adjust a degree of closeness of the muffler part to a body part of the wearer.

5. The integral detachable triple hat of claim 4, wherein the second protective member is provided with a Velcro for selectively coupling the other portion to the one portion of the second protection member.

6. The integral detachable triple hat of claim 1, wherein the muffler part and the mask part are detachably coupled to each other by a zipper.

7. The integral detachable triple hat of claim 1, wherein the muffler part is a protector that covers ears, a face side, and a chin in the face of the wearer.

8. A mask combined muffler comprising:
a muffler part covering a portion of a face of a wearer;
a mask part detachably coupled to the muffler part and filtering fine dust or viruses by covering a mouth and nose of the wearer; and
a mask filter provided in the mask part, the mask filter being replaceable.
